(19) United States
(12) Patent Application Publication
(10) Pub. No.: US 2003/0009099 A1
(43) Pub. Date: Jan. 9, 2003

(54) System and method for modeling biological systems

(76) Inventors: Gregory Scott Lett, Hightstown, NJ (US); Haoyu Yu, Lawrenceville, NJ (US); Jian Li, Plainsboro, NJ (US)

Correspondence Address: PHYSIOME SCIENCES, INC., 150 COLLEGE ROAD WEST, PRINCETON, NJ, 08540, US

(21) Appl. No.: 09/976,882

(22) Filed: Oct. 13, 2001

Related U.S. Application Data
(60) Provisional application No. 60/304,289, filed on Jul. 9, 2001.

(51) Int. Cl. G06F 9/45

(52) U.S. Cl. 600/416

(57) ABSTRACT

The present invention relates to a system and method for modeling a biological system. More specifically, the present invention relates to the use of a component-based architecture for biological modeling software, thereby enhancing the extensibility of the software and the reusability of the software components. The present invention also relates to the use of distributed components for constructing biological modeling software capable of being run in a distributed computing environment. Also provided are computer program products for implementing such methods and systems.

### CROSS REFERENCE TO RELATED APPLICATION

This application claims the benefit of priority of provisional U.S. patent application Ser. No. 60/304,289, filed Jul. 9, 2001, which is incorporated herein by reference.

### BACKGROUND OF THE INVENTION

1. Field of the Invention

The present invention relates generally to modeling biological systems. More specifically, the present invention relates to a system and method for modeling biological systems using a component-based architecture; the present invention also relates to a distributed computing architecture for implementing a system and method for modeling biological systems.

2. Description of the Background Art

Software models of biological systems are extremely valuable to researchers. Such models allow researchers, based on current theories about the inner workings of such systems, to predict the functioning of a biological system under specific circumstances. Before the development of software models, the evaluation of detailed models of most biological systems was impractical, due both to the large number of calculations that needed to be performed and to the need to understand thoroughly every aspect of the model.

One example of a software model of a biological system is the computational model for simulating the electrical and chemical dynamics of the heart that is described in U.S. Pat. No. 5,947,899 (Computational System and Method for Modeling the Heart), which is incorporated herein by reference. An example of a cell-level model of a biological system is the Virtual Cell, a software package developed at the University of Connecticut. The Virtual Cell and its capabilities is described in some detail in the following references: J. C. Schaff, B. M. Slepchenko, & L. M. Loew, “Physiological Modeling with the Virtual Cell Framework,” in Methods in Enzymology, vol. 321, pp. 1-23 (M. Johnson & L. Brand, eds., Academic Press, 2000); J. Schaff & L. M. Loew, “The Virtual Cell,” Pacific Symposium on Biocomputing 4: 228-39 (1999); C. C. Fink et al., “An Image-Based Model of Calcium Waves in Differentiated Neuroblastoma Cells,” Biophys. J. 79: 163-183 (2000); and J. Schaff et al., “A General Computational Framework for Modeling Cellular Structure and Function,” Biophys. J. 73(3): 1135-46 (1997). The Virtual Cell software package is also described in U.S. Pat. No. 6,219,440 (Method and Apparatus for Modeling Cellular Structure and Function), which is incorporated herein by reference.

Further examples of biological simulation software for modeling of biological and physiological systems include: DBsolve (see I. Goryanin et al., “Mathematical Simulation and Analysis of Cellular Metabolism and Regulation,” Bioinformatics, vol. 15, pp. 749-58 (1999)); GEPASI (see P. Mendes & D. Kell, “Non-Linear Optimization Of Biochemical Pathways: Applications to Metabolic Engineering and Parameter Estimation,” Bioinformatics, vol. 14, pp. 869-83 (1998); P. Mendes, “Biochemistry By Numbers: Simulation of Biochemical Pathways with GEPASI 3,” Trends Biochem. Sci., vol. 22, pp. 361-63 (1997); P. Mendes & D. B. Kell, “On the Analysis of the Inverse Problem of Metabolic Pathways Using Artificial Neural Networks,” Biosystems, vol. 38, pp. 15-28 (1996); P. Mendes, “GEPASI: A Software Package for Modeling the Dynamics, Steady States and Control of Biochemical and Other Systems,” Comput. Appl. Biosci., vol. 9, pp. 563-71 (1993)); NEURON (see M. Hines, “NEURON: A Program for Simulation of Nerve Equations,” Neural Systems: Analysis and Modeling (F. Eeckman, ed., Kluwer Academic Publishers, 1993)); GENESIS (see J. M. Bower & D. Beeman, The Book of GENESIS: Exploring Realistic Neural Models with the General Neural Simulation System, (2d ed., Springer-Verlag, N.Y., 1998)).

Numerous other simulation packages have been applied to modeling biological and physiological systems including: MetaCon (a DOS-based metabolic control analysis program available at ftp://bmshuxley.brookes.ac.uk/pub/software/ibmpc/metacon); Talis (a visual and interactive real-time tool for simulating metabolic pathways, gene circuits and signal transduction pathways); NetWork (a Java applet for interactive simulation of genetic networks); SCAMP (a command-line driven software package running on the Atari ST and MS-DOS operating systems; capable of simulating steady-state and transient behavior of metabolic pathways and calculation of all metabolic control analysis coefficients); MIST (a biological pathway simulation package running on MS Windows 3.1); MetaModel (MS-DOS-based software package for steady-state simulation of metabolic pathways); SCoP (a commercial simulation program that can be used to simulate metabolic systems); CONTROL (a DOS-based software package that uses the Reder matrix method to calculate control coefficients from elasticity values); FluxMap (a simulation package that calculates metabolic fluxes based on metabolite balancing); BioThermo (a simulation package that calculates the feasibility of individual pathway reactions based upon Gibbs free energy values and metabolite concentrations); BioNet (a metabolic flux analysis package); and the Matlab Simulink and Stateflow simulation packages.

Traditional software models of biological systems typically comprised a system of differential and/or algebraic equations, which often had to be translated into numerical approximations of those equations and then linked to a solver to solve the system of equations and to graphics libraries for displaying the results of the simulation. Early implementations of biological simulation software treated the entire model as a monolithic system of differential and algebraic equations. Hence, to make any change in a model, the software code typically had to be substantially rewritten. Given the rapid development of biological knowledge, such reprogramming has proven to be inconvenient and inefficient. In addition, software designed to model a specific biological system could not be readily adapted to model a different but related biological system. Therefore, a system using reusable software components, each representing some aspect of a biological system, would be desirable.

One approach to solving this problem consisted of carving up a large, complex model into a series of subparts or sub-models, and then organizing these sub-models in a hierarchical structure. Following this modular programming approach, a program would no longer consist of only one single part but rather would be divided into several smaller parts which interact through procedure calls and which form the whole program. The main program would coordinate calls to procedures in separate modules and would hand over appropriate data as parameters.

A modular programming approach does not, however, completely solve the above-described problems, and, in fact, creates some new ones. For example, many sub-models use global variables (whose values may be changed by other sub-models), making it difficult, if not impossible, to understand how a particular sub-model would function or behave without referencing the entire model. Indeed, for complex hierarchical models, it may be difficult to determine whether a particular variable is used or referenced before its value is first defined. Moreover, the actual simulation results would often depend upon the order in which the sub-models were parsed. Hence, sub-models cannot be readily reused as components in another model without redesign, and modifications to a model still would require a deep understanding of the algorithmic details of the software.

One approach to developing easily reusable software components is to adopt an object-oriented architecture. A traditional object-oriented architecture, however, usually uses inheritance to define the relationship between components and sub-components, which is frequently inappropriate in the context of biological modeling. Inheritance is a mechanism that allows one object or class (referred to as the child class or subclass) to be defined by reference to another object or class (referred to as the parent class or superclass). That is, the child class is able to access the attributes and methods of the parent class without the need to explicitly redefine those attributes and methods for the child class.

Oftentimes, in biological model, components and sub-components do not have a classic parent-child relationship. For example, a higher-level “parent” component such as a computational component for modeling a cell may comprise or encompass lower-level “child” components such as a nucleus component, a cell-membrane component and an endoplasmic reticulum component. However, these subcellular components may not share, and probably would not share, all of the attributes of the parent component. Hence, it would be inappropriate to define the subcomponents by inheritance.

Another drawback to conventional approaches to biological simulation is that they typically use a “single computer” architecture. That is, that processes and calculations are performed by a single processor on a single machine. In some cases, models of complex biological systems can be so large that they cannot be effectively evaluated on a single computer using presently available hardware (or can only be evaluated using prohibitively expensive hardware). It would therefore be useful to perform calculations relating to such models in parallel on multiple computers in a distributed computing environment. Hence, it would be desirable to create reusable software components capable of being used in a distributed computing environment. Moreover, because available computers are not always compatible, it would be desirable to utilize a platform-independent architecture to allow the use of the processing capabilities of many types of computers.

### SUMMARY OF THE INVENTION

In accordance with a first embodiment of the invention, there is provided a system and method for modeling a biological system, comprising a plurality of software components, each of which is connected to at least one other software components, and each of which directly communicate only with parent or child software components. In accordance with another aspect of the invention, there is provided a system and method for modeling a biological system, comprising a user interface and a simulation engine, wherein the user interface resides on a different computer than the simulation engine. In various embodiments, the simulation engine may include one or more of the following components: an ODE solver, a Solver Factory, and a Model Factory. In various embodiments, the user interface may include one or more of the following components: an XML parsing module, a mathematical equation generation module, and a visualization/display module.

In accordance with another aspect of the invention, there are provided a method and system of modeling a biological system, wherein each of a plurality of instantiated software components is connected to at least one other of the plurality of software components, each software component representing at least one of a physical portion of the modeled biological system and a functional aspect of the modeled biological system and data being directly communicated only between software components directly connected to each other. Also provided is computer-readable medium having stored thereon computer-executable instructions for performing the above-described methods.

In accordance with another aspect of the invention, there are provided a method and system for modeling a biological system, including a processor and a memory in communication with the processor, the processor causing a plurality of software components to be instantiated in the memory, the processor causing each of the plurality of software components to be connected to at least one other of the plurality of software components, each software component representing at least one of a physical portion of the modeled biological system and a functional aspect of the modeled biological system, and data being directly communicated only between software components directly connected to each other.

In accordance with another aspect of the invention, there are provided a method and system of modeling a biological system, wherein a software component is defined and instantiated dynamically and the software component is subsequently redefined. In one embodiment, the software component is defined by prototype.

In accordance with another aspect of the invention, there is provided a computer-readable medium having stored thereon a software component relating to a model of a biological system, including an attribute relating to at least one state variable, an attribute relating to an initialization method, and an attribute relating to a method of determining the rate of change over time of the at least one state variable.

In accordance with another aspect of the invention, there is provided a computer-readable medium having stored thereon an adapter relating to a model of a biological system, including an attribute relating to an expected output variable of a first component, an attribute relating to an expected input variable of a second component, and an attribute relating to a function for mapping the value of the output variable to a value that is a valid value for the input variable.

In accordance with another aspect of the invention, there are provided a method and system of evaluating at least one characteristic of a modeled biological system, including a plurality of connected software components, wherein the amount of time necessary to evaluate at least one characteristic on a first computer is estimated, a plurality of unselected connected software components is selected that can be evaluated within the predetermined length of time on another computer until the estimated time does not exceed a predetermined length of time, data relating to the attributes of any selected software components, data indicative of the state of the selected software components, data indicative of the rate of change of the state of the selected software components, and a direction to evaluate the selected software components without reference to the other software components in the modeled biological system are transmitted to the other computer, any unselected software components are evaluated without reference to the other software components in the modeled biological system, data indicative of a rate of change are received from each other computer to which data were transmitted, and the entire modeled biological system is evaluated.

In accordance with another aspect of the invention, there are provided a method and system for evaluating at least one characteristic of a modeled biological system, including a plurality of connected software components, the system including a first processor, a memory in communication with the first processor, and at least one additional processor in communication with the first processor, the first processor estimating the amount of time necessary to evaluate the at least one characteristic on a first computer, the first processor selecting a plurality of connected software components that can be evaluated within the predetermined length of time on one of said at least one additional processor and that have not previously been selected if the estimated time exceeds a predetermined length of time, the first processor causing to be transmitted to the one of said at least one additional processor data relating to the attributes of the selected software components, data indicative of the state of the selected software components, data indicative of the rate of change of the state of the selected software components, and a direction to evaluate the selected software components without reference to the other software components in the modeled biological system if any software components have been selected, the first processor evaluating any unselected software components without reference to the other software components in the modeled biological system, the first processor receiving from the one of said at least one additional processor, data indicative of a rate of change and the first processor evaluating the entire modeled biological system based on the received data and the calculated data.

### BRIEF DESCRIPTION OF THE DRAWINGS

FIGS. 1A, 1B and 1C illustrate systems in accordance with several embodiments of the present invention.

FIG. 2A illustrates a non-hierarchical view of the connections between multiple software components in a model in accordance with two embodiments of the present invention.

FIG. 2B illustrates a hierarchical view of the connections between multiple software components in a model in accordance with two embodiments of the present invention.

FIG. 3 illustrates a method in accordance with a first embodiment of the present invention.

FIG. 4 illustrates a method in accordance with the second embodiment of the present invention.

FIGS. 5A, 5B and 5C depict several approaches to implementing a distributed-component architecture.

### DETAILED DESCRIPTION OF THE INVENTION

The following terms shall have, for the purposes of this application, the respective meanings set forth below.

Adapter: A software component capable of adapting the interface of a software component to conform to the requirements of another software component. An adapter can change not only the inputs and outputs of a software component, but its function as well. Examples of uses of an adapter include: changing the physical units of an output of a model component; changing the mathematical problem type of a component; and adding equations or inequalities to the systems of equations defined by a model component. See Dan Becker, “Design Networked Applications in RMI Using the Adapter Design Pattern,” JavaWorld (May 1999).

Black Box Component: A software component that hides all of the details of its implementation such that the only details that need be known about the component to use it are details relating to its input variables and output variables, and the publicly available functions the component performs.

Characteristic: A characteristic of a modeled biological system includes, but is not limited to, any state variable of any component in the system. A characteristic can also relate to an experimental parameter that is not embodied in any specific state variable. The evaluation of a characteristic includes, but is not limited to, the determination of the value of a state variable of any component in the system at a specific time, or after the occurrence of an event (such as the addition of a chemical to the system), or the determination of the rate of change of the value of such a state variable.

Definition by Prototype: The definition of a software component or other software object by the description of a particular instance of that software component or other software object, rather than by means of an abstract declaration.

Dynamic Definition: The definition of a software component or other software object or other variable in such a fashion that any later redefinition of the software component or other software object or other variable will cause any previously instantiated software component or other software object or declared variable to conform to the revised definition. For example, a dynamically defined cell membrane component can include a method that defines the rate of sodium transport across it. That method can be used to calculate transport in the early stages of a simulation, but be redefined by other code to calculate transport differently. The redefined method would be used to calculate transport after such redefinition.

Functional Portion: Any portion of a modeled system that is not a physical portion of that system, such as a process for absorption of a chemical through a cell membrane.

Input Variable: A variable stored in a software component as a property or other field thereof that can or must be passed to that software component at initialization or later.

Instantiation: The creation of a specific instance of a software component or other software object at runtime.

Output Variable: A variable stored in a software component as a property or other field thereof that can or must be passed from that software component to another software component or other object or function.

Physical Portion: Any portion of a modeled system that is a tangible subpart of the entire system, such as a cell, a cell membrane, or a cell nucleus.

Software Component: Within the context of the present invention, a software component is a reusable program building block that can be combined with other components in the same or other computers in a distributed network to form an application. Examples of components include: a single button in a graphical user interface, a small interest calculator, an interface to a database manager. Components can be deployed on different servers in a network and communicate with each other for needed services. A component runs within a context called a container. Examples of containers include pages on a Web site, Web browsers, and word processors. Software components can also represent entities in the real-world, such as models of biological processes and sub-processes. They can also represent more abstract components necessary for building, storing, simulating and visualizing models. An example of an abstract component is an Adapter, which was defined above.

State Variable: A property or other field of a software component or other software object that represents a physical or functional aspect of a model. For example, a variable (whether or not publicly accessible to at least one other object or method) representing the concentration of a particular chemical in a cell is a state variable. All input and output variables are state variables, although a state variable need not be an input or output variable.

Commonly owned U.S. Pat. No. 5,947,899 titled “Computational System and Method for Modeling the Heart” and commonly owned U.S. patent application Ser. No. 09/295,503 (“System and Method for Modeling Genetic Biochemical, Biophysical, and Anatomical Information: In Silico Cell”), Ser. No. 09/499,575 (“System and Method for Modeling Genetic Biochemical, Biophysical, and Anatomical Information: In Silico Cell”), Ser. No. 09/599,128 (“Computational System and Method for Modeling Protein Expression”), Ser. No. 09/723,410 (“System for Modeling Biological Pathways”), and Ser. No. 09/898,151 (Method and System for Modeling Biological Systems) provide further discussion and explanation of various aspects of the modeling of biological systems and are hereby incorporated by reference in their entirety.

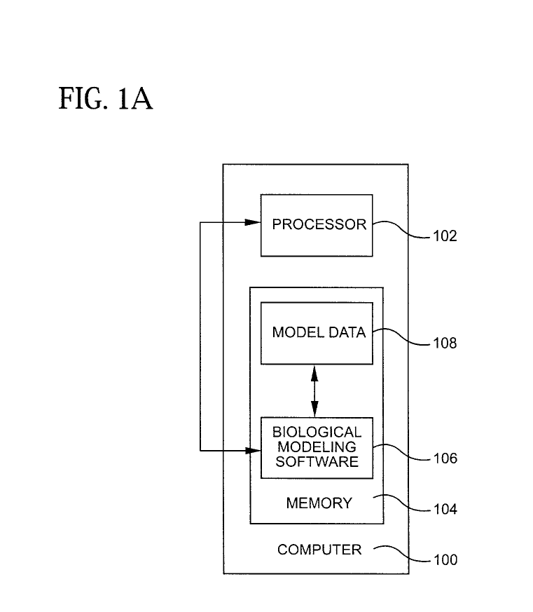

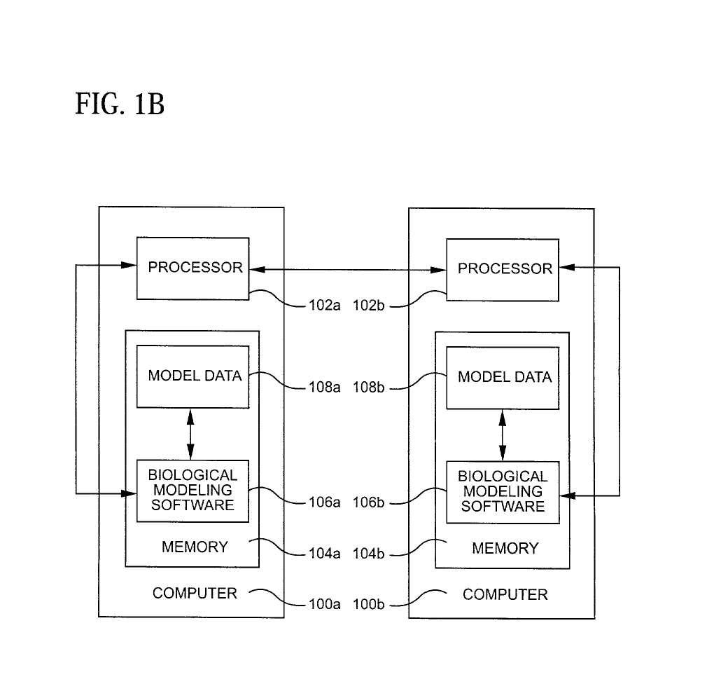

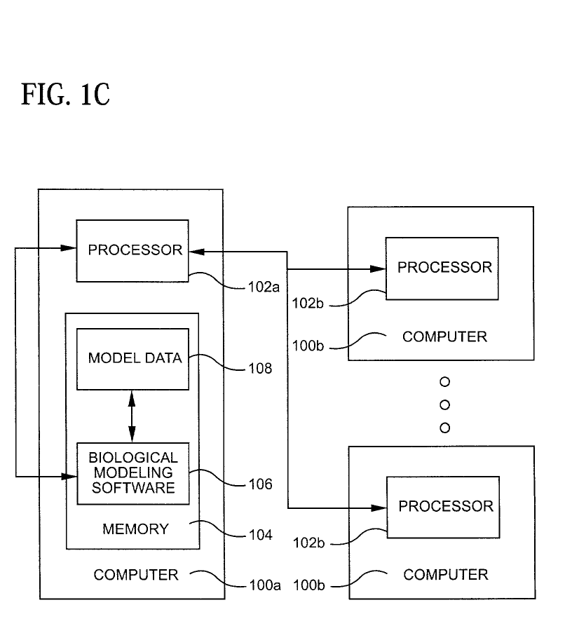

Referring to FIG. 1A, a block diagram of a system in accordance with a first embodiment of the present invention is illustrated. Computer 100 includes processor 102 and memory 104 connected to processor 102. Computer 100 can be a mainframe computer, minicomputer, microcomputer (including a personal computer or a workstation), or other computing device. Processor 102 can be an Intel Pentium or equivalent microprocessor, although other suitable processors can be utilized. Memory 104 can be permanent storage, such as a hard drive, temporary memory, such as random access memory, or a combination of permanent storage and temporary memory. Memory 104 typically includes both one or more hard drives and a form of random access memory. The first embodiment is most suitable for implementations in which a user's computer is likely to be powerful enough to evaluate models likely to be used by a typical user within a reasonable amount of time. At the present time, the second and third embodiments described below with respect to FIGS. 1B and 1C are more appropriate for the evaluation of complex models; however, if the processing capabilities of low cost computers continue to improve, the first embodiment could become more appropriate for the evaluation of complex models.

Referring to FIG. 1B, a block diagram of a system in accordance with a second embodiment of the present invention is illustrated. Computer 100a includes processor 102a and memory 104a connected to processor 102a. Computer 100a, which functions as a server, can be a mainframe computer, minicomputer, microcomputer (including a personal computer or a workstation), or other computing device, but is typically a supercomputer, such as SGI machine, running the Origin 2000 operating system. Processor 102a can be a R10K or equivalent processor, although other suitable processors can be utilized. Memory 104a can be permanent storage, such as a hard drive, temporary memory, such as random access memory, or a combination of permanent storage and temporary memory. Memory 104a typically includes both one or more hard drives and a form of random access memory.

Computer 100b includes processor 102b and memory 104b connected to processor 102b. Computer 100b, which functions as a client, can be a mainframe computer, minicomputer, microcomputer (including a personal computer or a workstation), or other computing device, but is typically a personal computer, such as an IBM compatible personal computer running the Microsoft Windows NT operating system. Processor 102b can be an Intel Pentium family or equivalent microprocessor, although other suitable processors can be utilized. Memory 104b can be permanent storage, such as a hard drive, temporary memory, such as random access memory, or a combination of permanent storage and temporary memory. Memory 104b typically includes both one or more hard drives and a form of random access memory. Computer 100a can communicate with computer 100b across the Internet, a private network, by direct modem to modem communication across telephone lines, or by other methods.

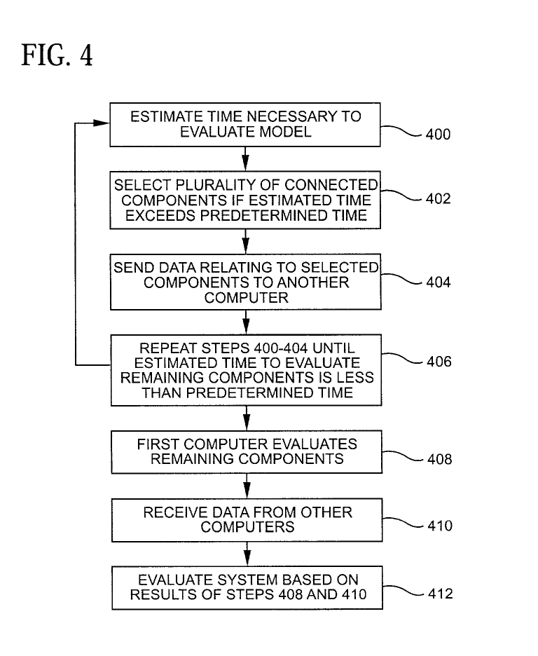

Referring to FIG. 1C, in a third embodiment of the present invention, a plurality of computers 100a through 100n are utilized and connected together by the Internet or other network. Large models can be broken down into multiple portions, with each portion being evaluated on a separate computer, with data from the evaluated portions being recombined and analyzed on a single solver computer. In yet other embodiments, this analysis can itself be broken down into portions and each portion can be analyzed on a separate computer, with a master solver computer combining the analysis to reach a final result. The use of multiple computers in connection with biological modeling is described in further detail in connection with the method illustrated in FIG. 4 below.

Referring to FIGS. 1A through 1C, biological model software 106 is stored in memory 104. In the second embodiment, part of biological model software 106 is stored in memory 104a and part is stored in memory 104b. For example, the user interface portions of the software, including the graphics functions, can be stored in memory 104b at the client, while the portions of the software dealing with the evaluation of models can be stored in memory 104a at the server. Biological model software 106 can be written in C++, Java, or one or more of many alternative programming languages utilizing object oriented methodologies. Numerous references, including Erich Gamma et al., Design Patterns: Elements of Reusable Object-Oriented Software (Addison-Wesley 1995) and Bertrand Meyer, Object-Oriented Software Construction (2d ed. Prentice-Hall 1997), teach how to program using an object-oriented language.

In a first, second, and third embodiments of the present invention, biological model software 106 preferably represents portions of a model (such as a single cell, a group of cells, a cell nucleus, or a particular pathway) as software components. In the third embodiment of the present invention, the components are preferably constructed in accordance with a platform and language independent standard, such as the Common Object Request Broker Architecture (hereinafter “CORBA”), to allow the components to be transmitted to a wide range of other computers, such as computers running incompatible operating systems. The CORBA specification is available from the Object Management Group of Framingham, Mass. (www.omg.org) and is hereby incorporated herein by reference in its entirety.

Model data 108 can be stored in a database, such as a relational or object oriented database, a flat file, such as an XML file, or other type of file. In certain embodiments, data relating to adapters can be stored in the same location or in a separate database or file. Oracle 8i or any suitable custom or commercial off-the-shelf relational, object oriented, or other database can be used to store model or adapter data. A portion or all of biological model software 106, model data 108, or both biological model software 106 and model data 108 can optionally be stored on an internal medium, such as a hard drive or random access memory chip or module, or on a removable medium, such as a floppy disk, tape, CD-ROM, DVD-ROM, removable hard drive, or other form of magnetic, optical, or other storage.

A variety of modeling languages can be utilized in accordance with the present invention. One such language is CellML, an extensible markup language designed for biological modeling. Portions of the biological simulation software may also be coded using MathML, which was originally developed as hypertext markup language for displaying mathematical equations but has been adapted for use in generating code for numerical computation (rather than merely rendering the equations for screen display or printing).

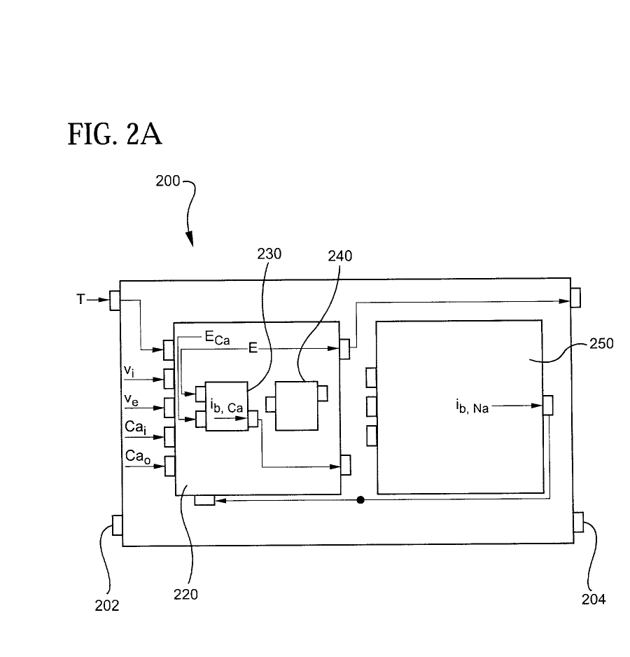

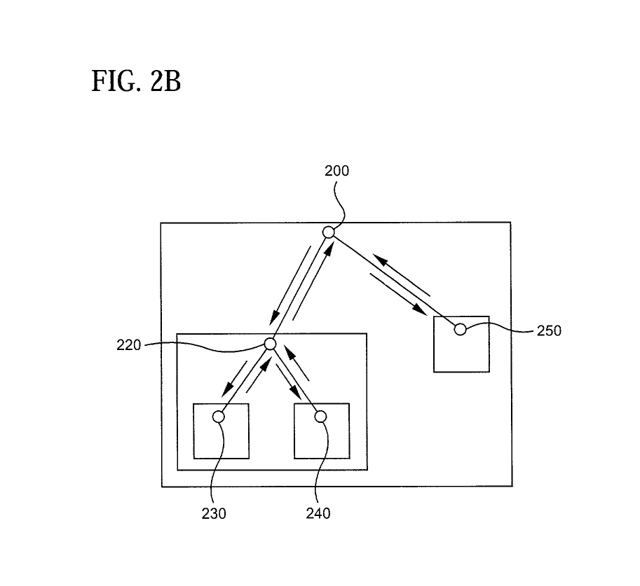

Referring to FIGS. 2A and 2B, two views of the connections between several components are illustrated. The non-hierarchical view of FIG. 2A illustrates the connections of component 200 with its sub-components. FIG. 2A does not illustrate all of the connections between the illustrated component and sub-component, and other components and sub-components, and the illustrated component and sub-components are far less complex than typical modeled components. Component 200 has one connected input variable, T, which is provided by a component that is not shown, and one connected output component, E, which is an output variable of child component 220. Component 200 provides six input variables to child component 220, namely its input variable T, four of its local variables, vₗ, vₑ, Caₗ, and Caₒ, and an output variable of child component 250, i_{b, Na} and receives one output variable, E, from component 220, and one output variable, i_{b, Ca}, from grandchild component 230. Grandchild component 230 has two input variables, E and E_{Ca}, both of which are local variables generated by child component 220, and one output variable, i_{b, Ca}, which it provides to child component 220. Grandchild component 240 has no connections, while child component 250 has no connected input variables and only one connected output variable, i_{b, Na}, which is a variable generated locally within child component 250. FIG. 2B illustrates the same component, sub-components, and connections in a hierarchical view.

Not all input and output variables need be connected in a model. For example, input variable 202 and output variable 204 of component 200 are not connected. In this case, a default initial value of input variable 202 is generated (if it is necessary) by some initialization procedure by component 200.

As will be seen from FIGS. 2A and 2B, in the exemplary embodiment, all communication is conducted between components that are directly connected to each other. Limiting communication to directly connected components eliminates the need of components to know details relating to the internal functioning of other components. Even if a variable is passed from one component to a second component, which may not use that variable internally, and on to a third component, the first component need not know what component will use that variable's value and the third component need not know the source of the value of that variable. Thus, components can be easily reused in a completely transparent fashion. For example, a researcher desiring to evaluate a system consisting of five components representing cells A through E can take a model that consists of cells A through D and cell F, disconnect and remove the component representing cell F, and add and connect a component for cell E. Because all of the interactions between the components representing the cells are handled on a direct component to component level, none of the connections between cells A through D among themselves are affected. Moreover, the creation of components composed of other components is greatly simplified. Finally, these components can be connected without any knowledge of the detailed structure of these components.

Notably, a group of connected components can be viewed as a component itself. In fact, a preferred method for creating a new component by assembling previously created components is a technique known as composition. Like class inheritance, composition is a mechanism for adding new functionality to a software class. In software design, composition is currently favored in most cases over inheritance because composition is more flexible and does not expose the internal implementation of a class.

The Composite Design Pattern, see Erich Gamma et al., Design Patterns: Elements of Reusable Object-Oriented Software (Addison-Wesley 1995), is also useful for assembling biological models from simpler models. It is very convenient to consider a model of biological processes to be made up of simpler processes. For example, the behavior of a liver cell can be conveniently described by the structures of the cell and the processes of the cell. In turn, it is convenient to consider even more complex models, e.g. a liver organ to be made up from a hierarchy of complex models, e.g. liver cells. The Composite Design Pattern allows the software to automatically treat any simple or complex model as a model component.

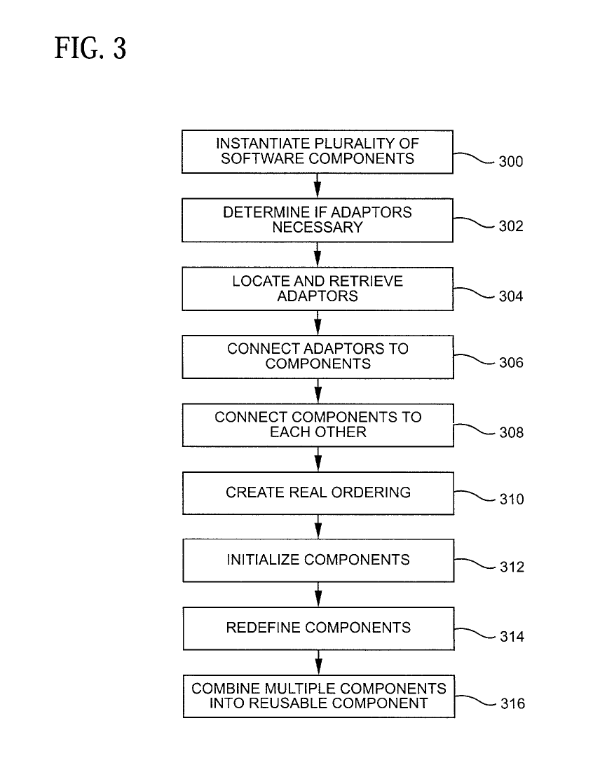

Referring to FIG. 3, a method in accordance with an exemplary embodiment of the present invention is illustrated. In step 300, a plurality of software components, such as those described above in connection with FIGS. 2A and 2B, are instantiated. The components can be either (i) first declared and subsequently instantiated (e.g., the component can be defined in a declarations section and instantiated in the body of the program) or (ii) defined by prototype, that is to say (with respect to the first instance of each class of component) simultaneously declared and instantiated (i.e., the component is both defined and instantiated at the same point in the program code). Each component preferably comprises one or more (but typically many) state variables, which describe important characteristics of the components. A state variable can be an input variable, an output variable, both an input and an output variable, or a purely local variable. The component preferably comprises one or more initialization methods for initializing any state variables that are not input variables. The component preferably also comprises one or more methods for determining the rate of change of its state variables over time.

In step 302, with respect to each connection between an output variable of a first component and an input variable of a second component that is to be made in a model, it is optionally determined whether an adapter is necessary. An adapter is necessary if the format of the output of the first component does not match the format of the input of the second component. The use of multiple adapters can be necessary with respect to some components, especially components having many input and output variables. For example, if the first component generates an output in degrees Celsius and the second component requires an input in degrees Kelvin, an adapter is necessary to translate from degrees Celsius to degrees Kelvin. Similarly, an adapter is necessary if data generated by the first component is slightly different from that required by the second component. For example, the first component could generate an output in units of force (such as pounds) while the second component required an input in units of mass (such as kilograms). An adapter would be necessary to map the first value to a second value using a formula including constants and a variable (the gravitational force of the earth or other relevant object). In some embodiments of the present invention, adapters are not utilized and the value of each output variable must be a valid value for the input of the input variable to which it is connected.

In step 304, an appropriate adapter is optionally automatically located and retrieved in each case in which an adapter is necessary. The use of consistent nomenclature or strong typing greatly facilitates the automatic retrieval of adapters. For example, if the output variable of a first component is of a degrees Celsius type or labeled as degrees Celsius, and the input variable of a second component is of a degrees Kelvin type or labeled as degrees Kelvin, it is a simple matter to query a database indexed on two type or label fields (one relating to the input to the adapter and one relating to the output) to locate an appropriate adapter. Alternatively, the user can be required to identify an appropriate adapter in embodiments in which adapters are utilized. In addition, in embodiments in which adapters are utilized, the user can be given the option to override the automatic selection of an adapter with another, more appropriate adapter.

In step 306, if adapters are used, they are connected to the appropriate components. In step 308, the components (or adapters connected to components) are connected together by associating input variables of components with output variables of other components.

In step 310, a real ordering of the order of initialization of the components of a model is created if the initialization methods of any state variables depend on values of state variables of other components. If a real ordering is not created, the order in which the components are initialized can affect the values of state variables that depend on values of state variables of other components. A real ordering can be created by first creating a directed graph comprising all of the dependencies of state variables on state variables of other components at the time of initialization and then using the partial order sort algorithm to convert the directed graph to a real ordering. In step 312, each component in the model is initialized.

In step 314, in embodiments in which dynamic declaration is utilized, components are optionally redefined after instantiation of specific instances. For example, if the introduction of a particular chemical causes a change in the basic functioning of a component, the component might be redefined upon the introduction of that chemical. Each previously defined instance of that component, as well as subsequently defined instances of the component, would assume all of the characteristics of the component as redefined.

In step 316, a plurality of components is optionally combined into a single reusable component. For example, biological model software 106 can include a method for automatically generating a wrapper allowing the user to view the plurality of components as a single component while treating the plurality as separate connected components for internal purposes.

Referring to FIG. 4, a method in accordance with a second embodiment of the present invention and usable in conjunction with the method described above in connection with FIG. 3 is illustrated. Prior to the performance of step 400, a model of a biological system is constructed using a plurality of connected components and the characteristics to be evaluated are provided to biological model software 106. In step 400, the amount of time necessary to evaluate the characteristic or characteristics of the modeled system is estimated. In certain embodiments of the present invention, the amount of time need not be measured with precision because the estimate is used only to determine whether multiple computers should be used to evaluate the model (or optionally the number of computers that should be used). The estimated time can be determined using several methods. The estimate can be calculated using only the number of software components used in the model, using the number of software components and the length of simulated time that the model will run, using the number of software components and the order of magnitude (e.g., n, n log n, n², etc.) of each algorithm in the model (or only selected algorithms), or using other methods.

In step 402, if the estimated time is longer than a predetermined length of time, a plurality of connected software components is selected. The selected components must be directly connected to each other, although each selected component need not be directly connected to each other component. The selected components must also be capable of evaluation within the predetermined length of time on another computer. The other computer can be any type of computer from a personal computer to a supercomputer; hence, it is desirable to know the type of computer that will be used before the performance of step 402. The components can be selected by dividing the model into an appropriate number of pieces and may take the capabilities of each other computer to which portions of the model will be sent into account or may take into account only the capabilities of the least powerful of such computer. The dividing lines between the portions of the model need not be logical.

In step 404, if any components have been selected in step 402, data relating to such components is sent to another computer together with a direction to evaluate such components. The data should include at least data relating to the current collective state of the components and their current collective rate of change. A platform independent standard such as CORBA can be used to send the data to the other computer. The collective state of the selected components can be represented as the union of all of their state variables and their collective rate of change can be represented as the rate of change of that union.

In step 406, steps 400 through 402 are repeated until any remaining software components can be evaluated within the predetermined length of time. In step 408, the first computer evaluates any remaining software components without reference to those sent to other computers. In step 410, data is received from the computers to which data was sent in step 404. In an exemplary embodiment, data indicative at least of a rate of change is received from each computer to which components were sent in step 404. In step 412, the entire modeled system is evaluated based on the results of steps 408 and 410.

Optionally, step 410 can be performed on a plurality of computers in a similar manner in complex models where the evaluation will likely consume an excessive amount of time. In this option, functional domain decomposition is utilized to perform various tasks comprising the evaluation of a model in parallel. The use of algebraic domain decomposition is well known to those skilled in the art. For example, U.S. Pat. No. 5,659,788, which patent is incorporated by reference herein in its entirety describes algebraic domain decomposition, which is typically utilized to divide a representation of a geometric object into subparts and to process such subparts in parallel. Functional domain decomposition involves the use of similar techniques in dividing the computations required to calculate the result of a function into tasks and to process such tasks in parallel.

First, the process of evaluation must be divided into a group of tasks that can be performed in parallel. Depending on the particular model, a greater or lesser degree of parallelism can be present. In any event, the final calculations required to generate an answer will in most cases not be capable of performance prior to the generation of other data. Many earlier calculations, however, can often be performed in parallel. Open MP or MPI can be used in this step. Second, at least some of the parallel tasks are sent to other computers to be performed and the results are received from such computers. Third, the results of the parallel tasks are combined. Fourth, any tasks that are not parallel are performed by the first computer. The analysis is then complete.

In an exemplary embodiment, a separate software component referred to as a solver is instantiated to perform a single task or group of tasks necessary to complete the evaluation of a model. In the exemplary embodiment, the several solvers instantiated to perform the tasks necessary to evaluate a model can be different from each other in many ways. They can be designed to apply different algorithms, run on different computing platforms, etc. The factory method (also known as a virtual constructor) is used to define an interface for creating a solver component, but allow subclasses to decide the class of solver component to instantiate.

The software components described above can be implemented using a variety of data structures. One way in which components of models and adapters can be implemented using XML. Other non-XML data structures are also suitable.

A Distributed Computing Approach

Another advantage of a reusable software-component architecture is that it lends itself to implementation of distributed computing solution. In a traditional design of a biological simulation model, all software components (except possibly for the database) would reside on a single machine, typically a desktop computer. The drawback to this design is that, as a model becomes more and more complex, the computational requirements of performing the simulation will gradually overwhelm a single computer's capacity in terms of computing power and memory. At some point, it will become necessary to move the software application to a more powerful computer with the ability to handle the increased computational loads.

In addition to the scalability and performance issues, another drawback is the need to reinstall the entire software package if one component, such as the solver, is upgraded and needs to be replaced. Hence, there is an inherent maintenance problem relating to deployment of upgrades.

The solution to these problems is to adopt a distributed computing architecture, with the user interface (UI) components and the computationally intensive solver components running on separate machines. For example, the UI can run on the user's desktop computer (or portable computer), while the simulation engine runs on a more powerful server, such as a supercomputer or a cluster of Linux machines. Optionally, if the problem's solution can be parallelized, there can be multiple numerical engines running on multiple computers, each solving subproblems of the larger problem. The UI components may also be split up to run on several machines. The distributed computing environment may comprise a number of computers directly linked in an intranet, or remote computers may communicate over the internet or by other means.

There are many standard distributed-computing technologies/architectures, including CORBA, DCOM, Enterprise JavaBeans, Remote Method Invocation (RMI), EJB, Parallel Virtual Machine (PVM), Message Passing Interface (MPI) and OpenMP. Preferably, the system is implemented using CORBA, which is platform-independent, language-independent, network-protocol-independent and object-oriented. The CORBA specification therefore allows the creation of interchangeable, reusable software components in heterogeneous computing environments. In comparison, the other standards suffer from one or more drawbacks. For example, DCOM, although in theory platform-independent, is not well-supported on non-Microsoft machines and is not an open standard; Enterprise JavaBeans, RMI and EJB are language-dependent; and PVM, MPI and OpenMP, which are parallel computing technologies for low-level message passing in a distributed environment, cannot directly transmit software objects and therefore cannot be easily adapted to implement an object-oriented system.

Because CORBA's Interface Definition Language (IDL) is independent of the implementation language, it is possible to choose the most appropriate programming language and execution environment for each component of the system under development. Moreover, because all objects interact through the IDL interface, legacy code (such as pre-existing numerical solvers, for example) can easily be integrated into the application. Alternatively, CORBA's dynamic interfaces (DII and DSI) can be used instead of IDL.

Furthermore, because all communication between objects and clients are enabled or mediated by the Object Request Broker (ORB), CORBA provides interoperability among components designed to run on different machines. That is, a client can invoke an object on a remote computer transparently and without regard to the location of the object or operating system under which the object is running. Finally, another advantage of CORBA is that there exist software tools for implementing fully secured distributed systems and for designing load-balanced applications.

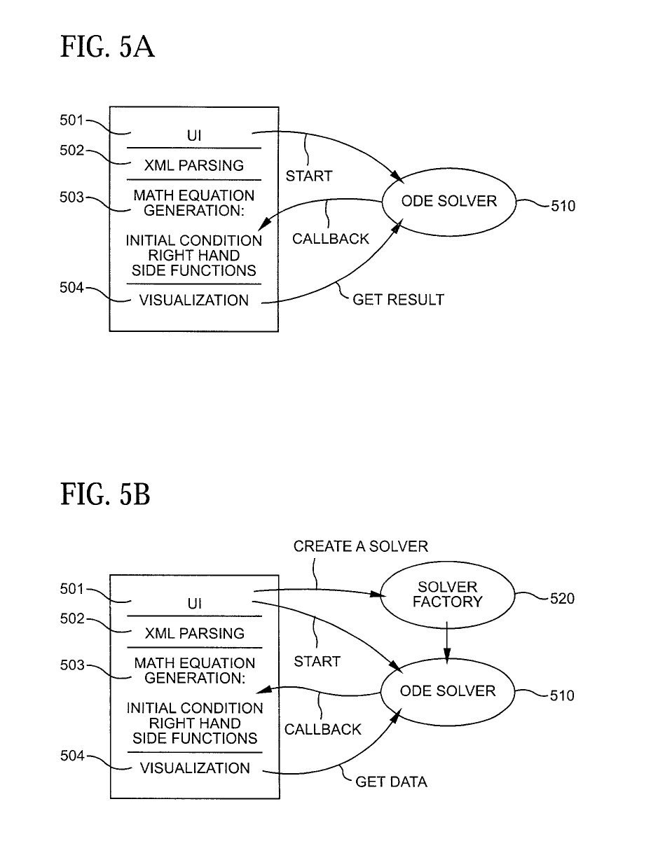

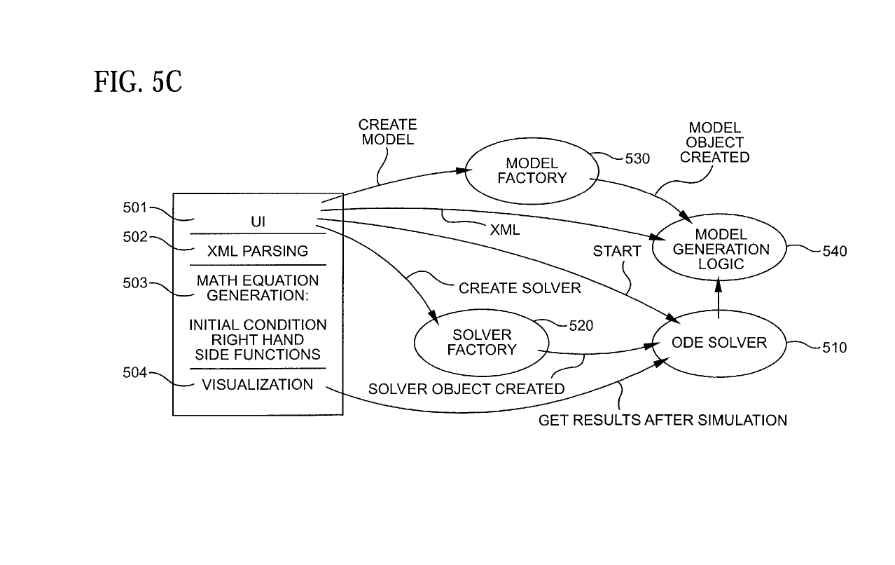

FIG. 5A depicts one embodiment of a distributed computing architecture, wherein the simulation engine or ODE Solver 510 is implemented as a distributed component running on a different host machine than the user interface or UI 501. The UI 501 will typically run on the user's local desktop computer; and the ODE Solver 510 will typically run on a remote server connected to user's machine on a local area network (LAN). Preferably, the UI 501 is implemented in JAVA. The ODE Solver 510 is any numerical solver capable of solving a system of ordinary differential equations (ODEs). The UI 501 allows the user to create, modify or view a biological model, as well as to enter and retrieve data relating to the model. Preferably, the UI 501 comprises a graphical user interface (GUI), and includes an editor (more preferably a WYSIWYG editor) for entering and viewing the underlying mathematical equations for the biological model, as well as the other modeling components or elements. For example, the UI 501 may include a “pathway editor” that allows the user to create, edit and view pathway diagram representations of the biological system being modeled; or the UI 501 may include a “cell editor” that allows users to create, edit and view cell-level components for cell modeling. In a preferred embodiment, the simulation model is stored in an XML format, such as MathML or CellML.

The UI 501, in the embodiment depicted, includes an XML Parsing component 502 and Math Equation Generation component 503 for translating the user input into a set of equations in a format that can be solved by the ODE Solver 510. The UI 501 preferably includes a Visualization component 504 that allows the user to view the model and data, as well as the simulation results.

As depicted in FIG. 5A, the CORBA IDL solver interface encapsulates the simulation engine (or ODE Solver 510) and allows the UI 501 to access the ODE Solver 510 only through the solver interface. In a preferred embodiment, the solver interface is implemented in C++ and is wrapped around a FORTRAN ODE numerical solver. The remote server application activates a servant object that implements the solver interface; and the server ORB converts the object reference into a standard string format. The ORB on the UI side converts this string back into an object reference.

After the simulation model is constructed, the UI 501 acts as a client and uses the object reference to make a series of invocations of the remote solver object to simulate the model. In response to each invocation, the solver computes a numerical solution and returns the solution to the UI 501 for display.

The embodiment depicted in FIG. 5A is perhaps the simplest design for separating the UI from the simulation engine, thereby unloading the computationally intensive components off the user's desktop machine. One drawback of this design is there is no means for the client to instruct the remote server to instantiate a new solver object.

A more flexible implementation is illustrated in FIG. 5B, which is similar to the embodiment depicted in 5A except that it introduces a Solver Factory object 520. The Factory Method (also referred to as a “virtual constructor” or a “creational design pattern”) is a method for abstracting the instantiation process. The Factor Method allows a class to defer instantiation to subclasses. That is, it defines an interface for creating an object but lets subclasses decide which class to instantiate.

As shown in FIG. 5B, the Solver Factory 520 allows for the creation of a solver object on demand. The remote server activates and publishes the Solver Factory object. The server can then defer the instantiation of a solver object until the client explicitly requests it. To actually create a new solver object, the UI 501 invokes an operation on the Factory object, which then creates a new solver object and returns a reference for the new solver object to the UI 501. The client need not know where the actual solver object resides; and the UI 501 needs only an object reference to initiate the simulation.

Although the embodiment illustrated in FIG. 5B is an improvement over the simple design show in FIG. 5A, it is still inefficient. Notably, during the numerical integration process, the ODE Solver 510 needs to know the right-hand side (RHS) functions for the ODE system being solved. Because the RHS functions reside on the UI machine, the ODE Solver 510 server must initiate a callback each time to retrieve the RHS functions. Since this callback event occurs many times during the simulation process, it may flood the communication channel between the computation server and the UI machine, thereby degrading the performance of the whole system.

FIG. 5C illustrates an embodiment, improving upon the designs shown in FIGS. 5A and 5B. In the embodiment shown in FIG. 5C, the callback process in removed entirely, and the model generation process (Model Factory 530 and Model Generation Logic 540) is encapsulated into the IDL interface and implemented on the remote server. In this embodiment, the UI 501 is a pure client and sends the model (preferably in the form of an XML file) to the remote server through an IDL operation. The UI 501 invokes the solver operations as before, but only once for each simulation. The simulation results are returned to the UI 501 for visualization only after the entire simulation process is completed.

As a result, the communication-overhead between the client machine and the server are reduced significantly. Hence, this implementation is more efficient. Moreover, multiple models may be simulated simultaneously using this implementation, thereby making this implementation more flexible than the two prior implementations described in FIGS. 5A and 5B.

All publications, patents, and patent applications mentioned in this specification are herein incorporated by reference to the same extent as if each individual publication or patent application were specifically and individually designated as having been incorporated by reference.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

That which is claimed is:

1. A method of modeling a biological system, comprising:
(a) instantiating a plurality of software components; and
(b) connecting each of the plurality of software components to at least one other of the plurality of software components,
wherein data are directly communicated only between software components directly connected to each other.

2. The method of claim 1, wherein step (b) comprises associating one or more input variables of a software component with one or more output variables of another software component.

3. The method of claim 2, wherein the one or more input variables and the one or more output variables each comprise at least one state variable.

4. The method of claim 1, further comprising:
(c) combining a plurality of connected components into a single reusable component.

5. The method of claim 4, wherein the single reusable component is a black box component.

6. The method of claim 1, further comprising:
(c) initializing at least one field of each of the plurality of connected components.

7. The method of claim 6, wherein the value of the at least one field in at least one of the plurality of connected components depends on the value of at least one field in at least one other of the plurality of connected components.

8. The method of claim 7, wherein with respect to each value that depends on the value of at least one field in at least one other connected component, data relating to the dependency is passed to at least one other connected component.

9. The method of claim 8, further comprising:
(d) creating a real ordering representing the order in which the fields will be initialized.

10. The method of claim 2, further comprising:
(c) connecting an adapter to at least one component,
wherein the adapter translates the output of the at least one component from a first format to a second format; and
wherein any other component receiving the output of the at least one component receives the translated value.

11. The method of claim 2, further comprising:
(c) connecting an adapter to at least one component,
wherein the adapter applies a function to the output of the at least one component to map the output from a first value to a second value; and
wherein any other component receiving the output of the at least one component receives the mapped value.

12. The method of claim 2, further comprising:
(c) connecting an adapter to at least one component,
wherein the adapter translates the input of the at least one component from a first format to a second format; and
wherein the component receives the translated value as input.

13. The method of claim 2, further comprising:
(c) connecting an adapter to at least one component,
wherein the adapter applies a function to the input of the at least one component to map the input from a first value to a second value; and
wherein the component receives the mapped value as input.

14. A method in accordance with any of claims 10 through 13, further comprising:
(d) determining whether an output variable of a first component attached to an input variable of a second component can supply to the second component a valid value to the second component;
(e) if the first component cannot supply a valid value, searching in a database of adapters for an adapter that can be connected to either the first component or the second component so as to transform the value of the output variable of the first component to a value that is valid for the second component; and
(f) if an adapter is found, retrieving the adapter and connecting it to the first component or the second component.

15. A method of modeling a biological system, comprising:
connecting each of a plurality of instantiated software components to at least one other of the plurality of software components,
wherein data are directly communicated only between software components directly connected to each other.

16. A system for modeling a biological system, comprising:
means for instantiating a plurality of software components; and
means for connecting each of the plurality of software components to at least one other of the plurality of software components,
wherein data are directly communicated only between software components directly connected to each other.

17. A computer-readable medium having stored thereon computer-executable instructions for performing the steps comprising:
(a) instantiating a plurality of software components; and
(b) connecting each of the plurality of software components to at least one other of the plurality of software components,
wherein data are directly communicated only between software components directly connected to each other.

18. A system for modeling a biological system, comprising:
a processor; and
a memory in communication with said processor,
wherein said processor causes a plurality of software components to be instantiated in said memory;
wherein said processor causes each of the plurality of software components to be connected to at least one other of the plurality of software components;
wherein data are directly communicated only between software components directly connected to each other.

19. A method of modeling a biological system, comprising:
(a) defining and instantiating a software component dynamically; and
(b) subsequently redefining the software component.

20. The method of claim 19 wherein the software component is defined by prototype.

21. A computer-readable medium having stored thereon a software component relating to a model of a biological system, comprising:
an attribute relating to at least one state variable;
an attribute relating to an initialization method; and
an attribute relating to a method of determining the rate of change over time of the at least one state variable.

22. The software component of claim 21, wherein the at least one state variable comprises a state variable relating to the concentration of a chemical.

23. A computer-readable medium having stored thereon an adapter relating to a model of a biological system, comprising:
an attribute relating to a first data format;
an attribute relating to a second data format; and
an attribute relating to a function for translating data from the first data format to the second data format.

24. A computer-readable medium having stored thereon an adapter relating to a model of a biological system, comprising:
an attribute relating to an expected output variable of a first component;
an attribute relating to an expected input variable of a second component; and
an attribute relating to a function for mapping the value of the output variable to a value that is a valid value for the input variable.

25. A method of evaluating at least one characteristic of a modeled biological system, comprising a plurality of connected software components, the method comprising:
(a) estimating the amount of time necessary to evaluate the at least one characteristic on a first computer;
(b) if the estimated time exceeds a predetermined length of time, selecting a plurality of connected software components that can be evaluated within the predetermined length of time on another computer and that have not previously been selected in any iteration of step (b);
(c) if any software components have been selected in the current iteration of step (b), transmitting to the other computer data relating to the attributes of the selected software components, data indicative of the state of the selected software components, data indicative of the rate of change of the state of the selected software components, and a direction to evaluate the selected software components without reference to the other software components in the modeled biological system;
(d) repeating steps (a) through (c) with respect to the modeled system without any software components previously selected in any iteration of step (b) until the estimated time does not exceed the predetermined length of time;
(e) evaluating any software components not selected in any iteration of step (c) without reference to the other software components in the modeled biological system;
(f) receiving from each other computer to which data was transmitted in any iteration of step (c), data indicative of a rate of change; and
(g) evaluating the entire modeled biological system based on data calculated in step (e) and received in step (f).

26. The method of claim 25, wherein the data relating to the attributes of the selected software components transmitted to the other computer in step (c) are transmitted using a platform independent distributed component-based architecture.

27. The method of claim 25, wherein step (g) comprises (1) dividing the evaluation of the entire modeled biological system into a plurality of tasks, (2) performing at least two of the plurality of tasks in parallel, (3) combining the results of the performed parallel tasks, and (4) performing any of the plurality of tasks not performed in parallel.

28. The method of claim 27, wherein the tasks performed in parallel are performed on separate processors.

29. The method of claim 27, wherein the tasks performed in parallel are performed on separate computers.

30. The method of claim 27, wherein the tasks performed in parallel are performed on separate computers linked together by the Internet.

31. The method of claim 27, wherein the tasks performed in parallel are performed on separate computers running different operating systems.

32. A computer-readable medium having stored thereon computer-executable instructions for performing the steps comprising:
(a) estimating the amount of time necessary to evaluate the at least one characteristic on a first computer;
(b) if the estimated time exceeds a predetermined length of time, selecting a plurality of connected software components that can be evaluated within the predetermined length of time on another computer and that have not previously been selected in any iteration of step (b);
(c) if any software components have been selected in the current iteration of step (b), transmitting to the other computer data relating to the attributes of the selected software components, data indicative of the state of the selected software components, data indicative of the rate of change of the state of the selected software components, and a direction to evaluate the selected software components without reference to the other software components in the modeled biological system;
(d) repeating steps (a) through (c) with respect to the modeled system without any software components previously selected in any iteration of step (b) until the estimated time does not exceed the predetermined length of time;
(e) evaluating any software components not selected in any iteration of step (c) without reference to the other software components in the modeled biological system;
(f) receiving from each other computer to which data was transmitted in any iteration of step (c), data indicative of a rate of change; and
(g) evaluating the entire modeled biological system based on data calculated in step (e) and received in step (f).

33. A method of evaluating at least one characteristic of a modeled biological system, comprising a plurality of connected software components, the method comprising steps for:
(a) estimating the amount of time necessary to evaluate the at least one characteristic on a first computer;
(b) if the estimated time exceeds a predetermined length of time, selecting a plurality of connected software components that can be evaluated within the predetermined length of time on another computer and that have not previously been selected in any iteration of step (b);
(c) if any software components have been selected in the current iteration of step (b), transmitting to the other computer data relating to the attributes of the selected software components, data indicative of the state of the selected software components, data indicative of the rate of change of the state of the selected software components, and a direction to evaluate the selected software components without reference to the other software components in the modeled biological system;
(d) repeating steps (a) through (c) with respect to the modeled system without any software components previously selected in any iteration of step (b) until the estimated time does not exceed the predetermined length of time;
(e) evaluating any software components not selected in any iteration of step (c) without reference to the other software components in the modeled biological system;
(f) receiving from each other computer to which data was transmitted in any iteration of step (c), data indicative of a rate of change; and
(g) evaluating the entire modeled biological system based on data calculated in step (e) and received in step (f).

34. A system for evaluating at least one characteristic of a modeled biological system, comprising a plurality of connected software components, the system comprising:
means for estimating the amount of time necessary to evaluate the at least one characteristic on a first computer;
means for repeatedly selecting a plurality of connected software components that have not been previously selected and that can be evaluated within the predetermined length of time on another computer until all of the unselected components can be evaluated on the first computer within the predetermined length of time;
means for transmitting to each other computer data relating to the attributes of any selected software components, data indicative of the state of the selected software components, data indicative of the rate of change of the state of the selected software components, and a direction to evaluate the selected software components without reference to the other software components in the modeled biological system;
means for evaluating any unselected software without reference to the other software components in the modeled biological system;
means for receiving from each other computer to which data was transmitted, data indicative of a rate of change; and
means for evaluating the entire modeled biological system based on the calculated data and the received data.

35. A system for evaluating at least one characteristic of a modeled biological system, comprising a plurality of connected software components, the system comprising:
a first processor;
a memory in communication with said first processor; and
at least one additional processor in communication with said first processor,
wherein said first processor estimates the amount of time necessary to evaluate the at least one characteristic on a first computer;
wherein, if the estimated time exceeds a predetermined length of time, said first processor selects a plurality of connected software components that can be evaluated within the predetermined length of time on one of said at least one additional processor and that have not previously been selected;
wherein, if any software components have been selected, said first processor causes to be transmitted to the one of said at least one additional processor data relating to the attributes of the selected software components, data indicative of the state of the selected software components, data indicative of the rate of change of the state of the selected software components, and a direction to evaluate the selected software components without reference to the other software components in the modeled biological system;
wherein said first processor evaluates any unselected software components without reference to the other software components in the modeled biological system;
wherein said first processor receives from the one of said at least one additional processor, data indicative of a rate of change; and
wherein said first processor evaluates the entire modeled biological system based on the received data and the calculated data.

36. A system for modeling a biological system, comprising
a plurality of software components, each of which is connected with at least one other software component,
wherein each of said components directly communicates only with parent or child components.

37. The system of claim 36, wherein said components are distributed components in a distributed computing environment.

38. A system for modeling a biological system, comprising
a user interface running on a first computer;
a simulation engine running on a second computer, wherein said user interface and said simulation engine each comprise at least one distributable component.

39. The system of claim 38, wherein said distributable components are CORBA components.

40. The system of claim 38, wherein said simulation engine includes an ODE solver component.

41. The system of claim 38, wherein said simulation engine includes a solver factory component.

42. The system of claim 38, wherein said simulation engine includes a model factory component.

43. The system of claim 38, wherein said user interface comprises a graphical user interface.

44. The system of claim 38, wherein said user interface comprises one or more of the following components: an XML parsing component; a mathematical equation generation component; and a visualization component.

45. The system of claim 38, wherein said user interface comprises at least two components running on at least two different computers.

46. The system of claim 38, wherein said simulation engine comprises at least two components running on at least two different computers.
